(19) United States
(12) Patent Application Publication
(10) Pub. No.: US 2025/0328314 A1
(43) Pub. Date: Oct. 23, 2025

(54) SIMPLE AND LINEAR FAST ADDER

(71) Applicant: Juan Pablo RAMIREZ, Zapopan, Jalisco (MX)

(72) Inventor: Juan Pablo RAMIREZ, Zapopan, Jalisco (MX)

(21) Appl. No.: 18/864,662

(22) PCT Filed: May 2, 2023
(86) PCT No.: PCT/US2023/066525

§ 371 Date: Nov. 11, 2024

Related U.S. Application Data
(60) Provisional application No. 63/340,865, filed on May 11, 2022.

(51) Int. Cl. G06F 7/57

(52) U.S. Cl. CPC G06F 7/57

(57) ABSTRACT

Disclosed herein is a fast adder design based on a novel axiomatization of mathematics, of natural and real numbers, by the author. Addition is a Finite State Machine that, on an average, takes logon iterations to calculate a n-bit addition. Further, for the proposed fast adder, the probability of a n-bit addition taking k≤n iterations to complete, is equal to the probability of k consecutive heads in n fair coin tosses. The circuitry is linear and simple, in the sense that adding bits to the inputs does not complicate the circuit topology. The growth is linear, and the instruction set is constant, and hardware based.

### BACKGROUND

The subject matter of the present invention is related to a general-purpose fast adder, in the form of a synchronous sequential circuit. Particularly, the present invention proposes a fast adder defined in terms of a finite state machine that replaces traditional carry-over algorithms of addition, based on a novel axiomatization of mathematics, by the author. The adder constitutes a direct application of this foundation of mathematics which serves as supporting material for several aspects, including further applications, of the Simple and Linear Fast Adder.

Efficient and inexpensive Central Processing Units (CPUs) or processing units with low dissipation are an ever growing priority. One of the crucial subunits of the CPUs is an Arithmetic Logic Unit (ALU). Typically, the ALU is responsible for performing the actual arithmetic and logical operations in the CPUs. The efficiency and performance of the ALU generally depends on specific components of the ALU, namely, the adder and the bit shift component.

One of the basic problems with an existing adder, such as a Ripple Carry Adder, is the propagation delay. A traditional solution to overcome this is to use a parallel adder. Further, other solutions such as a Carry Look-Ahead (CLA), Carry Select, Carry Skip, and Carry Increment adders face their own problems. For example, in the case of CLA, if the number of bits is increased, the area and complexity of the circuit increases considerably. Therefore, the CLA fast adders of more than four bits are generally built using parallel 4-bit adders. This multi-level structure adds up to the propagation time delays.

In view of the above limitations in the existing adders, it would be advantageous to have an adder that offers linear growth and complexity irrespective of the increase in the number of bits.

The information disclosed in this background of the disclosure section is only for enhancement of understanding of the general background of the invention and should not be taken as an acknowledgement or any form of suggestion that this information forms the prior art already known to a person skilled in the art.

### SUMMARY

It is an objective of the present invention to provide a general-purpose fast adder having a small count of ‘AND’ and ‘XOR’ logic gates, setting a new standard in the design and manufacture of ALU by providing efficiency that is comparable to parallel adders, while having a reduced material, production, and energy costs.

It is a further objective of the invention to design a fast adder that is implemented based on an arithmetic and real number model and which can be implemented for operation on signed and rational approximations to real numbers, with a few minor modifications.

It is a further objective of the invention to provide a universal fast adder of linear area, with logarithmic time delay.

In view of the foregoing, an embodiment of the present disclosure relates a general purpose fast adder that is in the form of a sequential logic circuit, based on a finite state machine that is not time constant. On an average, it takes log₂ n iterations to complete addition of two n-bit numbers. The proposed fast adder has the advantages of linear growth and complexity, in the sense that adding one bit of input requires adding a subunit consisting of four registers and five logical gates, and the subunits are connected in series. The instruction set does not increase when the number of bits is increased. The performance of the adder is potentially comparable to the existing fast adders, while using five logical gates (one XOR, and four AND) and four registers of memory, per bit of input. In an implementation according to the present invention, the four bit adder presented here uses sixteen AND gates, four XOR gates and sixteen one bit registers. This adder has linear area and complexity, and logarithmic delay. The power dissipation of the adder is theoretically constant, due to constant gate depth. Instruction set is also constant and independent of the number of bits of input.

In an implementation, the proposed invention is flexible and compatible with different signed representations. The proposed ALU architecture is able to support operands for integer and rational approximations to real numbers. As an example, the operations can include, without limiting to, left/right shift (multiplication/division by 2), addition, signed operations, and other operations derived thereof. Additionally, the present invention also proposes a three operand adder.

In an embodiment of the present disclosure, the four-bit adder component is configured to support a plurality of operands for integer type data and rational approximations to real number type data.

In another embodiment of the present disclosure, the four-bit adder component is configured to perform operations comprising at least one of left shift operation, right shift operation, addition, signed operations and one or more derived operations. In an embodiment, performing the operations comprises representing the numbers in a binary form in corresponding set of natural numbers, such that, each number is a set of smaller natural numbers, wherein elements of the set of smaller numbers are denoted in powers of 2 in a binary representation.

In another embodiment of the present disclosure, the linear fast adder comprises determining a symmetric difference corresponding to the operations performed at the four-bit adder component, the determining comprising saving an initial state of the operations in at least one one-bit registers in the four-bit adder component, directing output of each of the one-bit registers in two disjoint paths and computing the symmetric difference and intersection in the output of each of the one-bit registers. In an embodiment, the bit configurations saved in the one-bit registers are passed through at least one XOR gate in the four-bit adder component for yielding the symmetric difference. The bit configurations saved in the one-bit registers are passed through at least one AND gate in the four-bit adder component for determining intersection in the output.

In another embodiment of the present disclosure, to represent a rational approximation of non-negative real numbers, a fraction of the bits is used for the rational part and the remaining bits are used for the integer part.

In another embodiment of the present disclosure, adding a single bit to the operands requires adding of a sub-unit of four bits and five logic gates in a linear manner to the four-bit adder component.

In another embodiment of the present disclosure, the time taken by the linear fast adder is equal to the sum of the two gate delays, and the reading and writing process.

In another embodiment of the present disclosure, clock cycles for the linear fast adder remain shorter depending on the gate depth and constant instructions, such that an increase in speed of memory writing process results in a compounded reduction of time.

In another embodiment of the present disclosure, an instruction set associated with the linear fast adder is constant and is independent of the number of bits of input provided to the linear fast adder.

In another embodiment of the present disclosure, the operation of the linear fast adder is controlled based on an arithmetic model that defines addition operations in terms of a finite state machine. Here, each state of the finite state machine comprises two columns and each column represents a finite configuration of energy levels representing one natural number. In a subsequent state of the finite state machine, the finite configuration on the left column of the two columns represents the energy levels that are not repeated in the preceding state and the finite configuration on a right column of the two columns represents objects that are repeated from the preceding state.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the leftmost digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows a graphical representation of an exemplary operation (15+23=38), in accordance with some embodiments of the present disclosure.

FIG. 2 shows an external view of one-bit data register, in accordance with some embodiments of the present disclosure.

FIG. 3 illustrates use of exemplary registers RA/RA′ and RB/RB′ with input “i”, output “o” and logic gates, in accordance with some embodiments of the present disclosure.

FIG. 4 shows a full view of a four bit adder along with ‘Enable’ and ‘Set’ and connections to the control unit, in accordance with some embodiments of the present disclosure.

FIG. 5 shows a flow diagram for the instruction set, where the instruction set is constant and independent of the bit length of inputs, in accordance with some embodiments of the present disclosure.

FIG. 6 shows addition of rational and real numbers as an extension of the natural number arithmetic proposed, in accordance with some embodiments of the present disclosure.

FIG. 7 shows a complete structure of the fast adder, compatible with multiplication and division, in accordance with some embodiments of the present disclosure.

FIG. 8 shows an exemplary control unit and its internal parts, in accordance with some embodiments of the present disclosure.

FIG. 9 shows an alternative arrangement of the fast adder including double edge triggered flip flops, in accordance with some embodiments of the present disclosure.

FIG. 10 shows a basic subunit for the fast adder, such that one of these subunits handles one bit of input and is connected in series to give an n-bit adder, in accordance with some embodiments of the present disclosure.

FIG. 11 shows a modification of the subunit, which is modified to handle three inputs, in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the specific forms disclosed, but on the contrary, the disclosure is to cover all modifications, equivalents, and alternatives falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus preceded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

An overview of the proposed invention:

For a better understanding of the proposed invention, the following paragraphs provide an introduction to the simple mathematical background of the arithmetic logic and provide a general overview of the invention. In an embodiment, the numbers are written in binary form. However, instead of treating numbers as a sequence of binary symbols, they are treated as sets of natural numbers. For example, the integer seven, 7=111 in binary form, would be represented as the set of natural numbers {0, 1, 2}. The number twelve, 12=1100, is represented by the set {2, 3}. The number 21=10101 is represented by the set {0, 2, 4}. Each natural number is a set of smaller natural numbers, and the elements of the set are the powers of 2 in binary representation.

Similarly, addition is also treated in terms of sets, and not sequences. For example, consider the sum 7+13=(2⁰+2¹+2²)+(2⁰+2²+2³), which is the sum of sets {0, 1, 2}⊕{0, 2, 3}. Here, two new sets are formed-symmetric difference and intersection. That is, the powers that are not repeated {1, 3}, and the powers that repeat {0, 2}. To add a power of 2 with itself (i.e., numbers in the intersection), simply add “1” to that power, 2ⁿ+2ⁿ=2ⁿ⁺¹. Therefore, the sum can be rewritten as 7+13=(2¹+2³)+(2⁰⁺¹+2²⁺¹). The first term, 2¹+2³, represents the symmetric difference AΔB, while the second term 2⁰⁺¹+2²⁺¹=(2⁰+2²)+(2⁰+2²) represents the intersection. The sum has been reduced to 7+13=(2¹+2³)+(2¹+2³). Iterating, there is no symmetric difference. And, adding “1” to the repeated powers gives 7+13=2¹⁺¹+2³⁺¹=2²+2⁴=20.

If A, B are two finite sets of natural numbers, they can be added using the same method. Form two new sets A′=AΔB and B=s(A∩B), where s is the function that adds one unit, 1, to the elements of A∩B. Then A+B=A+B′. It is guaranteed that, in a finite number of iterations, the intersection A^{(k)}∩(B^{(k)}=0 becomes the empty set. This yields the final answer A^{(k+1)}, because

$$\begin{matrix}A + B = {A}^{( k + 1 )} + {B}^{( k + 1 )} \\ = {A}^{( k + 1 )} + s ( ∅ ) \\ = {A}^{( k + 1 )}\end{matrix}$$

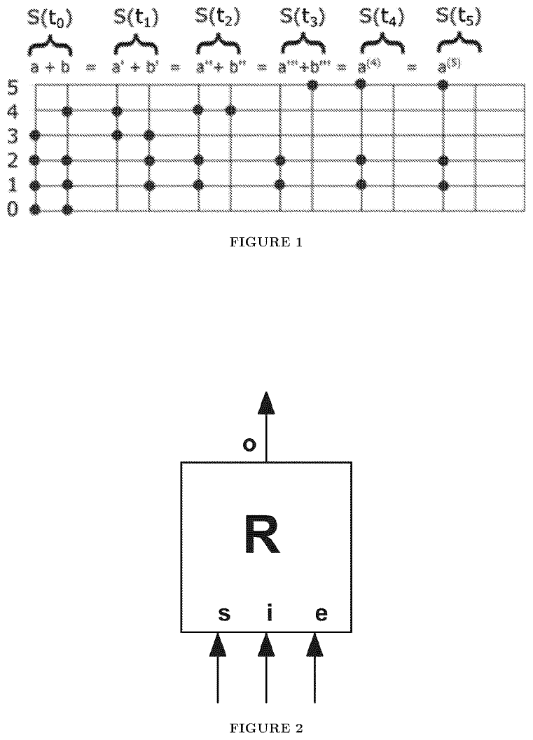

A second example is 15+23=38 of FIG. 1. The operands in the initial state are A={0, 1, 2, 3}, and B={0, 1, 2, 4} because 15=2⁰+2¹+2²+2³ and 23=2⁰+2¹+2²+2⁴. The second state is A′=AΔB={3, 4}, and B′=s(A∩B)={0+1, 1+1, 2+1}={1, 2,}. The next state is given by A″=A′ΔB′={1, 2, 4} and B″=s(A′∩B′)={3+1}={4}. Iterating again gives A′″={1, 2} and B′″={4+1}={5}. Iterating once more, a stable state is reached; A⁽⁴⁾={1, 2, 5} and B⁽⁴⁾=0.

The process described herein is a finite state machine. Each state is composed of two columns. Each column is a finite configuration of energy-levels representing one natural number, as is illustrated in FIG. 1. A particle in the basic level “0” is worth 1 unit, and a particle in level “1” is worth 2 units. A particle in level “2” is worth 4 units, and in general a particle in level “n” is worth 2ⁿ units. A finite configuration of particles in a column represents a set number, so that each state is a pair of natural numbers. As shown FIG. 1, the initial state S(t₀) is given by the inputs A, B. The next state, S(t₁) is given by two new columns. The configuration of the left column is given by the energy levels that were not repeated in state S(t₀). The right column in S(t₁) is given by the repeated objects, displaced one level up. The configuration of state S(t₂) is defined similarly in terms of state S(t₁). The left column of state S(t₂) is given by the energy levels not repeated in state S(t₁). The configuration in the right column of state S(t₂) is given by the energy levels repeated in state S(t₁) but displaced one level up. In general, the left column of state S(tₖ₊₁) is given by the energy levels not repeated in state S(tₖ). The right column of state S(tₖ₊₁) is given by a displacement, one level up, of the energy levels repeated in state S(tₖ). In a finite number of steps, a stable state is reached, where no particle occupies the right column. The result of the sum is given in the left column.

In an embodiment, the basic idea behind the circuit implementation of this addition algorithm is to receive two inputs A, B and output two new numbers A′=(AΔB) and B′=s(A∩B). These two new numbers will satisfy A′+B′=A+B. Iterate the process using A′, B′ as new inputs, to obtain A″, B″ which satisfies A″+B″=A+B. In a finite number of iterations B^{(k)} becomes zero. For a finite integer k, it is true that B^{(k)}=0 and the sum is A^{(k)}=A+B. This process will take, on average, log₂ n steps, where n is the number of bits. It takes at most n steps to terminate, and the probability for the process to end in k≤n steps is the probability of k successive heads in n coin tosses.

In an embodiment, to add two n bit numbers, four n bit registers. RA, RA′ and RB, RB′ are required. For example, RB′ is the register of bits RB′0, RB′1, . . . , RB′(n−1). Registers will have “set” and “enable” connections for read and write functions, respectively. When registers RA and RB are on “set”, registers RA′ and RB′ are on “enable”. Similarly, when registers RA and RB are on “enable”, registers RA′ and RB′ are on “set”.

In an embodiment, the initial state S(t₀) is saved in the RA and RB registers. These registers output their stored memory which will go through two different paths. One path will treat symmetric difference and the other will handle the intersection. The bit configuration saved in RA, RB is enabled to go through XOR gates, yielding symmetric differences. The definition of symmetric difference is equivalent to the truth table of the XOR gate. The output of each XOR gate will be saved in the same significant bit of the RA′ register. On the second path, intersection is determined by AND gates. The output of each AND gate will be saved in the next significant bit of the RB′ register. The intersection is displaced one level up, and this is reflected with the bit shift. At this point, state S(t₁) is stored in registers RA′, RB′. This represents the first iteration of our finite state machine. The bits stored in registers RA′, RB′ will be enabled to move through the XOR and AND gates. The result will be saved in the RA, RB registers, storing state S(t₂) in registers RA, RB. Continue to move back and forth in this manner until the stopping condition is met. The stopping condition is that the output of RB/RB′ (whichever is enabled) is equal to the zero vector.

The following components are needed. Four n bit registers, RA, RA′, RB, RB′. A total of n XOR gates, and 4n AND gates with bit shift. The XOR determines symmetric difference and stores the results in the same significant bit. The AND gates provide the intersection, and the bit shift represents the rule 2^{k}+2^{k}=2^{k+1} applied to the objects of the intersection. Additionally, a Zero Flag “Z” checks for the stopping condition. Namely, that the right column, RB/RB′ is off. The Zero Flag will take the value “Z=1” if any of the outputs from register RB/RB′ are “1”. It will take the value “Z=0” if and only if all of the outputs of register RB/RB′ are “0”. When the Zero Flag turns off, the Sum “S” is the set of signals S₀, S₁, S₂, S₃, which are output from register RA/RA′.

A bit shift requires three iterations to complete. Multiplication by 2 is the addition s(A)==A⊕A=2⊙A. Find A′=AΔA=0 and B′=s(A∩A)=s(A). The result is a displacement of A, one unit up, saved in register RB′. One more iteration gives A″=A′ΔB′=0Δs(A)=s(A) and B″=s(A′∩B′)=s(0∩s(A))=s(0)=0. In the third and final iteration, the stopping condition is met, because register RB outputs the zero vector. The sum is the output “S”, of register RA.

Configuration and operation of the depackaging assembly:

In an embodiment, the functioning of each individual register is explained in detail in the following paragraphs. There is one data input “i” and one data output “o”. Additionally, two more input signals are included. A set signal “s” to write, and an enable signal “e” to read. If “s” is a high signal “i”, the data input “i” is stored in memory. If “e” is high, then the last input saved on memory is the data output “o” of the register. The external view of the data latch is shown in FIG. 2. The process described here will never have “e” and “s” on at the same time (nor will “e′” and “s′” be on at the same time). When one is on the other is off, so that the bits will never read and write simultaneously to avoid error. Only “s,e′” are on at the same time, as are “e,s′”. This same function can be described using different read and write processes. The first model presented here, for illustrative purposes, is a level triggered version. A more efficient alternative is later described in this document using dual edge triggered flip flops which require a much more simple Control Unit.

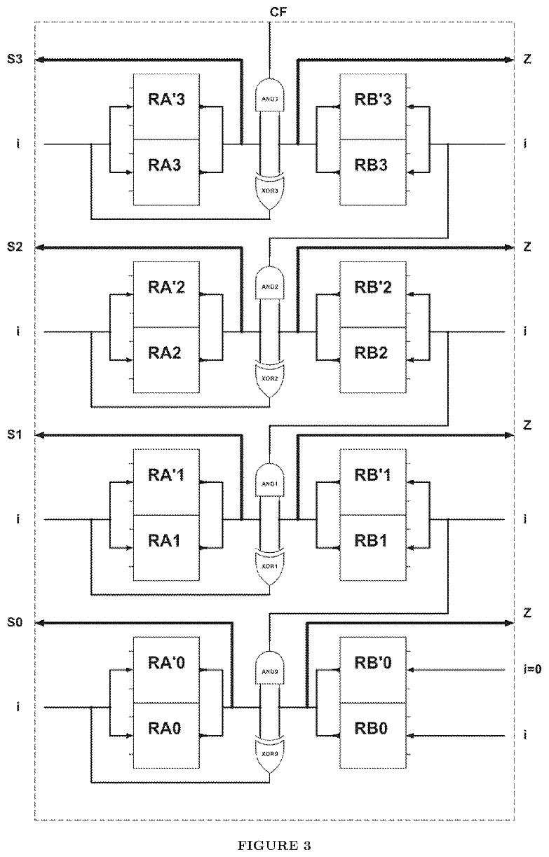

In an embodiment, implementation of the n-bit ALU requires four n bit registers, RA, RB, RA′, RB′. This is shown in FIG. 3. Registers are arranged so that ‘XOR’ and ‘AND’ gates are placed in between the two columns of registers RA/RA′ on the left and RB/RB′ on the right. The output of the XOR gates is directed into registers RA/RA′, while the output of the AND gates is directed into registers RB/RB′ with a bit shift. Symmetric difference of the two columns will be saved in the left column RA/RA′, and the intersection with a bit shift will be saved in the right column RB/RB′. For every bit of input, a subunit of two gates and four bits of memory is required.

The data inputs “i=A₀, A₁, A₂, A₃” and “i=B₀, B₁, B₂, B₃” are only activated at the beginning of the instruction set. At the same time, a high set signal “s” is activated. The result is that the initial state S(t₀) is stored in registers RA, RB. The Zero Flag “Z”, and Sum “S” are also shown in FIG. 3. The connections “Z” and “S” are outputs of the registers: inputs to the CU. The Zero Flag determines if the stopping condition is met, “Z=0”. Namely, that the output from register RB/RB′ is zero, 0000. The “S” connections coming from register RA/RA′ will represent the resulting sum, when the stopping condition is met. A Carry Flag “CF” connection is included.

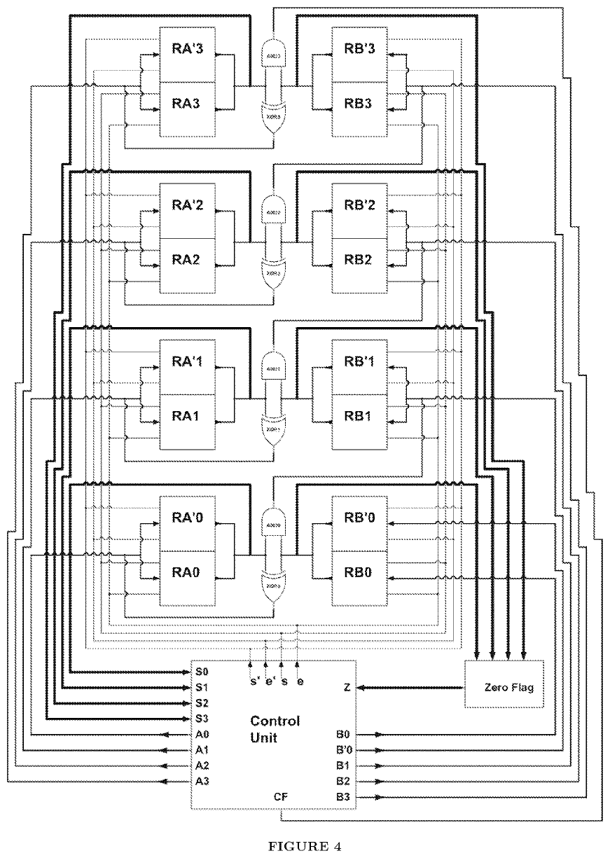

The Input/Output connections and logic gates are placed on the top laver, while “Z” and “S” are on a second layer, below the latter. This is shown in FIG. 4. In an embodiment, the set and enable connections of FIG. 4, “s,e,s′,e′” are each on their own layer so they do not intersect with each other, nor with the top two layers. The four layers of set and enable connections are represented by four thin lines that do not intersect. They function in the following manner. If “s′” (write RA′, RB′) is on, then “e” (read RA, RB) is on simultaneously. Similarly, if “e′” (read RA′, RB′) is on, then “s” (write RA, RB) is on.

A total of six layers of connections are needed. Four bottom layers for set and enable connections, and the two top layers for “i”, “o” and “Z”, “S”. Three different line thicknesses are used in FIG. 4 to reflect this. Thin lines are used for the set “s” and enable “e” connections and they are placed at the bottom. Thick lines are placed on top of the four layers of thin lines and are used for “Z” and “S”. Medium thickness lines are placed at the top layer and are used for input “i” and output “o”.

The first step in the process is to write the data input signals i=A₀, B₀; A₁, B₁, A₂, B₂, A₃, B₃ in the registers RA0, RB0, RA1, RB1, RA2, RB2, RA3, RB3, respectively. The data connections appear at the bottom of the Control Unit in FIG. 4. This first step is achieved by activating the data input “i” signals, along with the set “s” signal. The input signals are on low “0” or high “1” according to the inputs A, B being represented. The input connections are activated only once at the beginning of the instruction set. Simultaneously, the set signal “s” is high “1”. There is one exception. After the initial data input into RB0, the bit shift requires a “0” input into RB′0, then it will require low “0” to be input into RB0. This continues in an alternate manner until the stopping condition is met. This is specified in the instruction set. A “U” signal is sent to RB′O, the first time “s′” is activated, and every iteration after that “0” is sent to RB0/RB′0 in an alternate manner as explained.

In an embodiment, the second step is to output the data signal “o” of the RA, RB registers. This is achieved with a high enable “c” signal. The data outputs of RA, RB will go through the XOR and AND gates. At the same time “s′” is also on, so that RA′, RB′ registers write the output of the gates. The result is that the second state of the finite state machine is saved in the RA′, RB′ registers. The next iteration is to output the bits stored in RA′, RB′ and write the result on the RA, RB bits. This is achieved by turning on “e” and “s” simultaneously. The third state of the system is stored in memory, in the RA, RB registers. Continuing in this manner for a finite number of iterations leads to a stable state; the output of register RB/RB′ will be 0000 in a finite number of states. The result is the Sum “S” output of register RA′.

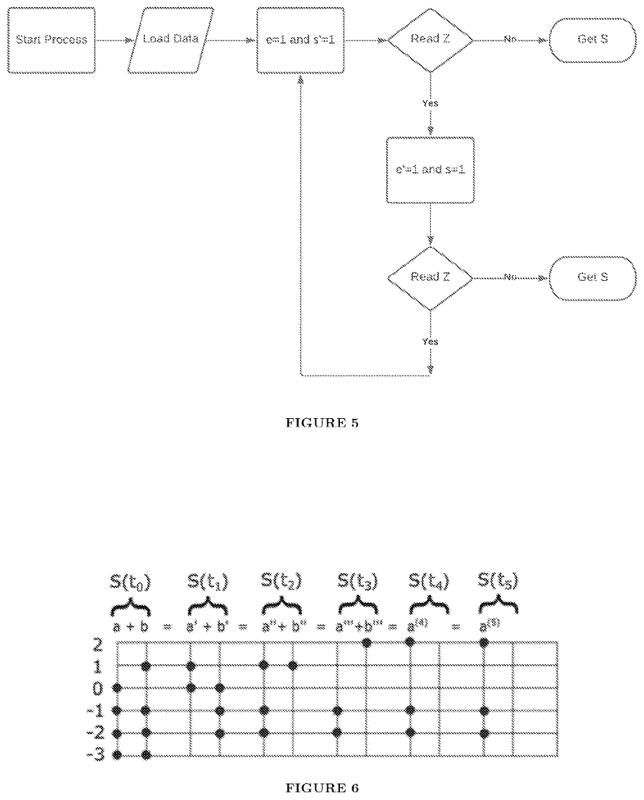

FIG. 5 shows a flow diagram for the instruction set, where the instruction set is constant and independent of the bit length of inputs, in accordance with some embodiments of the present disclosure. The instruction set for the flow diagram is given below:
1. Load data inputs i=Aᵢ, Bᵢ to registers RAi, RBi, and activate Set “s=1”.
2. Activate Enable “e=1” and Set “s′=1”. Load data input “i=0” to RB′0 bit.
3. Read Zero Flag “Z”
   If “Z=0”, Get “S”;
   Else “Z=1”, Activate Enable “e′=1” and Set “s=1”. Load data input “i=0” to RB0 bit.
4. Read Zero Flag “Z”
   If “Z=0”, Get “S”;
   Else “Z=1”, Go to II.

These instructions can be carried out largely by Hardware. This will be explained later in the document.

An example is illustrated in the following paragraphs. Let A=6=0110 and B=3=0011. The corresponding instructions are listed below:
I. First instruction will load inputs A=0110 and B=0011 to registers RA, RB. That is, RA0=0, RA1=1, RA2=1, RA3=0, and RB0=1, RB1=1, RB2=0, RB3=0.
II. Subsequent instruction will read the contents of registers RA, RB. These contents are directed to the XOR and AND gates. The output of these is written on the RA′, RB′ registers. In our example, the outputs of RA0, RB0 are “0,1”, respectively. These outputs will then be directed to the XOR0 gate, and input “1” into RA′0. Simultaneously, the same “0,1” outputs, from RA0, RB0, will also be directed into the AND0 gate which will input “0” into RB′1. In an embodiment, the output of registers RA1=1, RB1=1 will input “0” into RA′1 and “1” into RB′2, after going through gates XOR1 and AND1, respectively. The outputs of RA2=1, RB2=0 will write “1” into RA′2 and “0” into RB′3 after passing through XOR2 and AND2. Also, RA3=RB3=0 will write “0” into RA′3. The bit-shift requires the CU to input “0” into RB′0. While these outputs go through the gates and the results are written, the output of the RA, RB registers will be sent to the CU in the form of “S₀=0, S₁=1, S₂=1, S₃=0” and “Z=1”, respectively.
III. The subsequent instruction will read “Z=1”. The action path is to read RA′, RB′ and write the results on registers RA, RB. The results are RA0=1, RB0=0, RA1=0, RB1=0, RA2=0, RB2=0, RA3=0, RB3=1. Again, the bit-shift requires a “0” input into RB0. At the same time, the output of RA and RB has been sent to the CU in the form of “S₀=1, S₁=0, S₂=1, S₃=0” and “Z=1”, respectively.
IV. The subsequent instruction will read “Z=1”. Then, go to Instruction II.
II′. Outputs the memory of RA, RB into RA′, RB′. The result will be RA′0=1, RA′1=0, RA′2=0, RA′3=1, and RB′0=RB′1=RB′2=RB′3=0. At the same time, the output of RA and RB has been sent to the CU in the form of “S₀=1, S₁=0, S₂=0, S₃=0” and “Z=1”, respectively.
III′. will read “Z=1”. The action path is to read RA′, RB′ and write the results in RA, RB. At the same time, the output of RA′, RB′ is sent to the CU as “S₀=1, S₁=0, S₂=0, S₃=1” and “Z=0”, respectively. This concludes the program, with “S” being the result of addition of the original inputs; 6+3=9.

To represent a rational approximation of a non-negative real number, a fraction of the bits is used for the rational part and the remaining bits are used for the integer part. This gives us operation for fixed point rational numbers. The examples given are of fixed point nature. However, this ALU architecture is compatible with floating point representation and operations.

Negative energy levels are identified with negative powers of 2. Therefore, a set of negative integers will give a unique number in the unit interval [0, 1]. For example, the set {−1} is the number ½=2⁻¹. The set representation of ¾=2⁻¹+2⁻² is the set {−1,−2}. Consider the finite state machine of FIG. 1. Notice that changing the labels on the energy levels gives a new expression. For example, making the bottom level equal to 3, instead of 0. This means 3 is added to every element of a set number. Instead of 15+23={0, 1, 2, 3}⊕{0, 1, 2, 4}, the new addition is {0+3, 1+3, 2+3, 3+3}⊕{0+3, 1+3, 2+3, 4+3}={3, 4, 5, 6}⊕{3, 4, 5, 7}=120+184. The new result is obtained by adding 3 to all the elements of the original result, {1+3, 2+3, 5+3}={4, 5, 8}=304.

In an embodiment, if the energy levels are displaced into negative integers, the results still hold a true expression. In FIG. 6, an example of this is provided. The addition of sets with negative integers in its elements is the same as before. The addition ¼+¼={−2}⊕{−2} is equal to ½={−1}. The set addition is ({−2}Δ{−2})⊕s({2}∩{2}); first term is the empty set, and the second term is s ({−2})={−2+1}={1}.

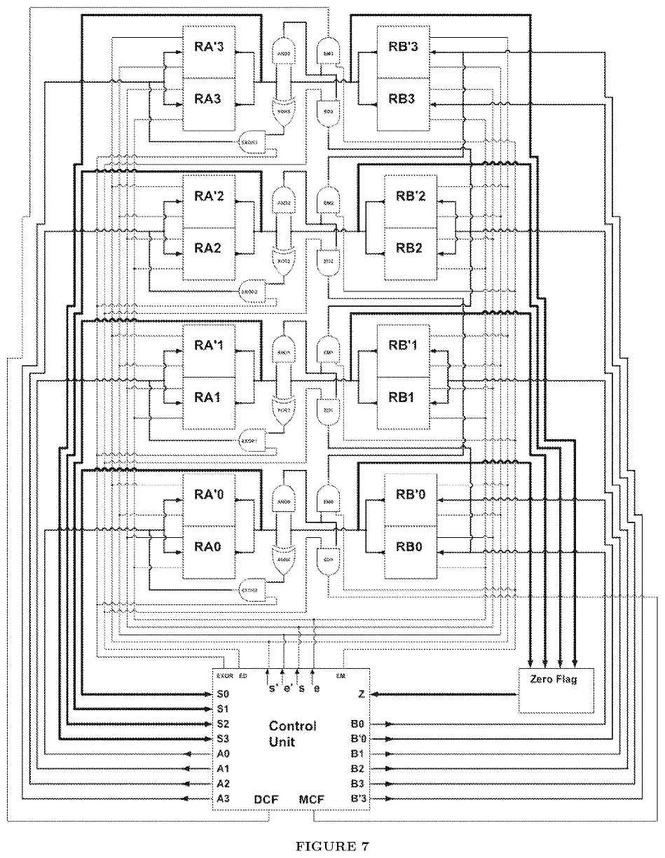

The circuit for adding numbers whose elements include negative integers does not require any additional components. The circuit of FIG. 4 suffices. However, to divide numbers by 2, a second bit shift is needed. This is easily achieved by adding two enabling AND gates to each AND gate of the ALU. One gate will Enable Multiply “EM” and the other will Enable Divide “ED”. Only one of these can be on at a time and must remain on during the entire time of the operation. Carry flags for multiplication “MCF” and division “DCF” are also included. This is illustrated in FIG. 7. A connection for input in RB′3 is also included for division, just as an input connection is included for RB′0.

One more component should be included in the description of the ALU. Once an addition is performed and new data inputs are to be loaded, the registers will be receiving signals from the CU and the XOR gates because when “s” is on, so is “e′”. To solve this, an AND gate is placed after each XOR gate. This enables the symmetric difference just as the “ED” and “EM” gates enable the intersection. These gates will be called “EXOR”, and one of its inputs is connected to the output of its corresponding XOR gate and the other is a high signal whenever “EM” or “ED” are a high signal. This is a viable solution because it also gives a two gate depth to the XOR path, as in the case of the AND path. The XOR and AND paths have equal gate depth.

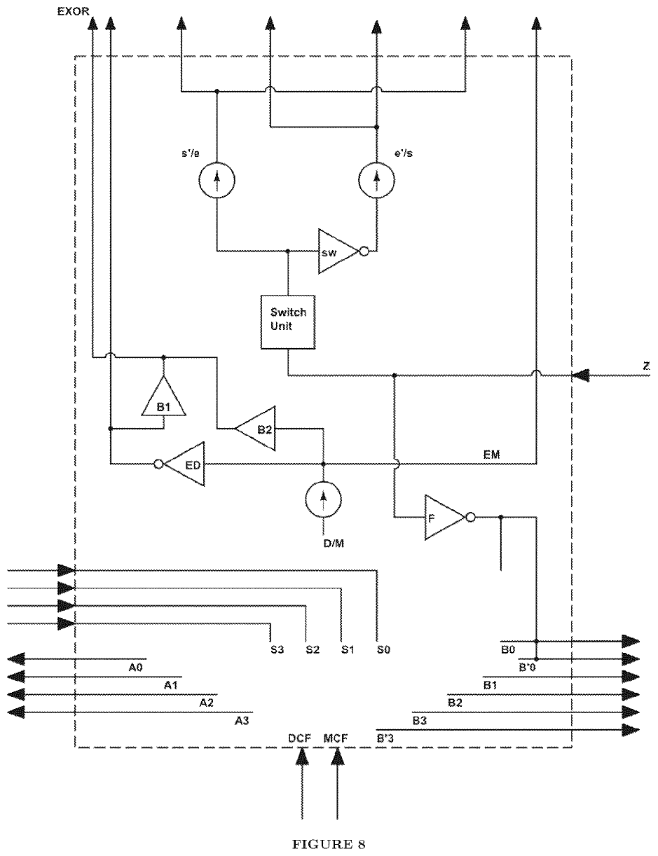

In an embodiment, the control logic is designed simple enough to show in a diagram. FIG. 8 is an internal view of the Control Unit. Step I requires set connection “s” to be on. This is achieved with a high signal in “e′/s”. Simultaneously, the data inputs are also sent to the registers. Step II Requires for “s′/e=1” to be turned on. This will read registers RA and RB and write on registers RA′ and RB′. The output of register RB will, at the same time, be directed to the Zero Flag “Z”. A “Switch Unit” is included to perform the following function. The first time “Switch Unit” receives high input. “Z=1”, it will output a low signal to “s′/e”. The next time the switch unit receives a high signal “Z=1”, it will output a high signal. That high signal will go to gate “sw” so that now a low signal is directed to “e′/s”. This continues in alternating manner so that the output of the switch unit moves between high and low, starting with a low signal. When the switch unit receives a low signal, there is no output because the stopping condition has been met.

In an embodiment, the control unit has an input “D/M”. If addition is to be performed, “D/M=1” should be on. Bit shift equivalent to multiplication by 2 is performed if both inputs are equal. If the signal is low “D/M=0”, then “ED=1” and the operation performed is division by 2 when both inputs are equal. The carry out connections “DCF” and “MCF” are shown again. The “EXOR” signal is given by gates “B1” and “B2”: it is on whenever “ED” or “EM” are on. A flag “F” is included for internal use of the CU. The flag is on when the stopping condition is met; the flag turns on when Z turns off. It can be used to save the Sum “S” in memory once the addition is completed. It is also used to indicate when new data inputs are loaded to the registers, and it shuts off “ED”, “EM” and “EXOR”. The flag is also used for outputting a zero value to RB0/RB′0. In the case of division, the bits RB3/RB′3 take their place.

In an embodiment, increasing the number of input bits increases the area linearly. This is a box-car architecture, where adding a bit to the operands requires to add a sub unit of four bits and five logic gates in linear manner (add a box car). A n-bit adder requires 4n many bits of registers, a many XOR gates, and 4n many AND gates. Compared to other fast architectures, this represents a significant reduction in material resources and area. The requirements are the same number of registers, and reduced gate count, area, and complexity. Furthermore, the instruction set remains the same, for any number of bits.

The finite state machine is not time constant. Calculation time is constant for equal inputs, but differs for different inputs. Let t, the time length for one iteration, then t·log₂ n is the average time to complete an addition, and the longest time is t·n. The circuit bas a fixed gate depth of two logic gates, plus the lengthiest micro steps of reading and writing memory. This allows easy calculation of the time it takes to perform one iteration. It is equal to the sum of the two gate delays, plus the reading and writing process.

In an embodiment, the circuit is designed to have easy synchronization, independent of the choice of logic, clock speeds and register type. Particular solutions abound and are routine. The general principal of modeling the finite state machine through a logical circuit is being described. In terms of area, the CLA has area of order O(n log₂ n), while the area of the fast adder here proposed is of linear order O(n). The ratio of these two orders is O(log₂ n). Approximately log₂ n many fast adders, of the type here proposed, may fit in the same space of one CLA of equal bits, as n gets bigger. Also, CLA performs in one clock cycle, while the proposed adder considers a positive number of iterations, on average log₂ n many iterations. It is concluded that performance is expected to be comparable in terms of area and speed, as the number of bits, n, and the number of operations performed, grow. This is true if the clock cycles of the compared adders are of equal time length. It must be considered that the clock cycles for the proposed adder will be shorter because the gate depth is a small constant and instructions are constant. This effect will potentially give better performance than other fast parallel adders. This design is likely to operate at higher than conventional clock speeds. If the memory writing process can be sped up, then the whole process will have a compounded reduction of time, and possibly outperform other fast adders, bit for bit.

Another advantage of the present invention would be power consumption, because the control logic and gate depths are a small constant number. The design can be adapted to specific applications such as general purpose, graphics, scientific, etc.

A second example is provided, illustrating the internal process of the adder and the control unit. This example will illustrate a bit shift to the right, which is equivalent to division by 2. In this case, let A=B=0111. The result of the operation is A+B=0011, and the carry flag “DCF” will be activated in the process. Load the data inputs; the set connection “s” is set to high. Simultaneously, the data inputs of A and B are activated. Ou every iteration that follows, the “D/M” input in the CU will be set to low so that the division gates “ED0-ED3” are enabled in the ALU. Thus, bits are carried to the right, not the left. Next, the “s′/e” input of the CU is turned on. This will enable reading of the RA, RB registers, and writing on RA′, RB′ registers. Specifically, registers RA0=1, RB0=1 will both input a high signal to gate “AND0”, turning it on. Therefore, gate “ED0” will be turned on and it will be sending a signal to the division carry flag “DCF”. This will simply indicate that a carry over to the right is taking place in the first bit. At the same time, the corresponding process takes place for the other bits, registers RA1=1 and RB1=1 turn gate “AND1” on. This turns gate “EDI” on, sending a high signal to register RB′0. A similar situation happens with the next bit, RA2=RB2=1. These send a high signal to RB′1. The last bit, RA3=RB3=0 will send a low signal to RB′2. Also, a low signal is sent to RB′3 as part of the instruction set. At the end of this process the configuration of the registers is RA′=0000 and RB′=0011. While this is taking place, the outputs of register RA are also sent to the Zero Flag. Since at least one of these bits is on, “Z” is on.

The high signal of “Z” will go into the switch unit which will output a low signal, initiating the second iteration. Registers RA′=0000, and RB′=0011 are read and then pushed through the XOR and AND gates. The output of the gates is written on registers RA=0011, and RB=0000, respectively. The output of the Zero Flag is “1”, so a high signal goes into the switch unit which will output a high signal. This will read registers RA and RB. The output of register RB is the zero vector, so that the output of the zero flag is a low signal “Z=0”. This signals RA to be saved in memory or operate where it is needed. At the same time, it will signal for the “ED”, “EM”, and “EXOR” to be off in the next clock cycle so that new data can be input to the registers without error. This example suggests that it could be convenient to have a Zero Flag for register RA, also. This last implementation would subtract one iteration from the bit shift.

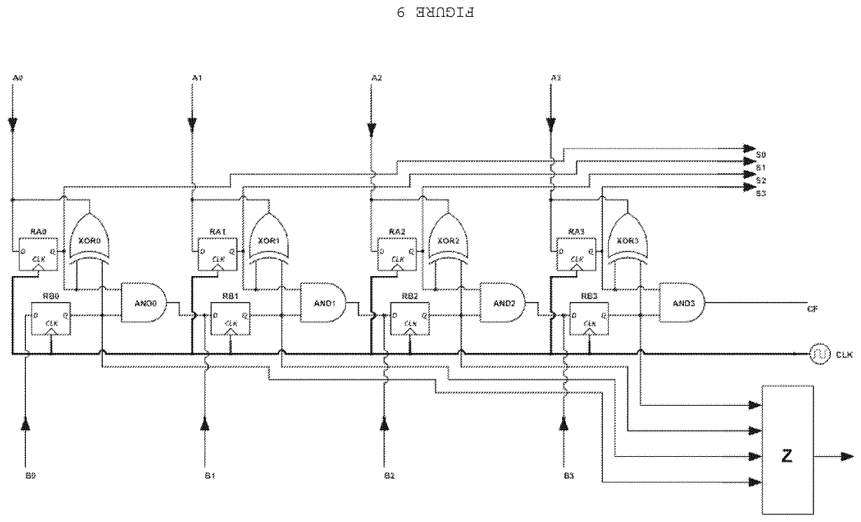

Two sets of registers RA, RB, RA′, RB′ were used because of the racing problem. The outputs of the XOR and AND gates are looped back to the registers. That is why a rudimentary master-slave solution has been illustrated. However, that solution is not the most efficient. An alternative solution is presented. A variation of the proposed ALU can be implemented using edge triggered registers. If the registers are replaced for memory bits capable of handling inputs/outputs independently and without error of feedback, then the number of memory registers is reduced. A total of two n bit registers will suffice. Edge triggered registers offer a solution. A register with three connections is used: clock “CLK”, input “D”, and output “Q”. Each register will have to read on the positive edge and write on the negative edge of the clock cycle. This is shown in FIG. 9. Enable divide, enable multiply, and enable EXOR gates are not shown.

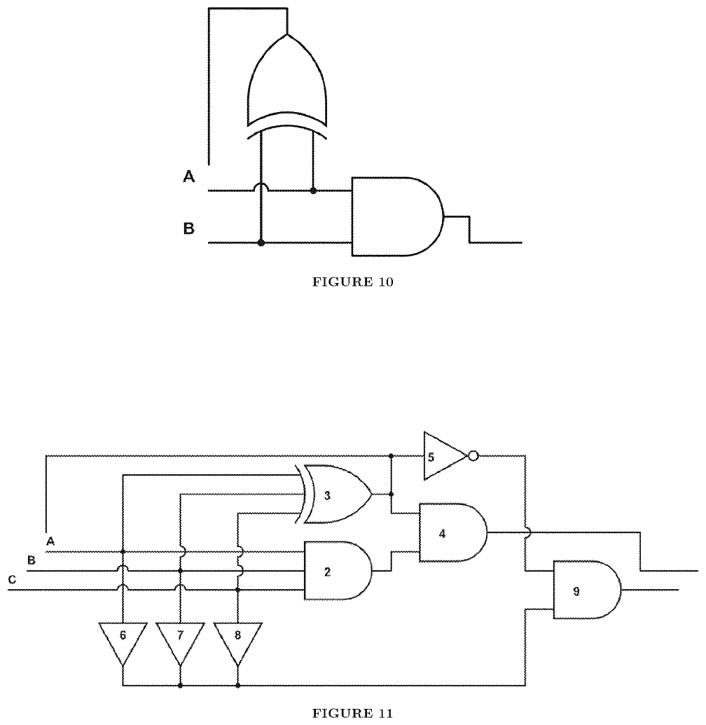

A three operand version is possible and comparable to Carry Save Adder. The proposed unit should yield better performance when adding positive numbers. The expected sign difficulties of CSA are still present for signed operations of three operands. A comparison is given between the gate topology for a two operand unit in FIG. 10, and a three operand unit in FIG. 11.

In an embodiment, FIG. 10 shows the basic sub unit that allows for the iterative process on one-bit. It consists of a half adder where the output of AND is connected to the register RB(i+1) of the next bit, representing the new configuration in the right column of the finite state machine. The output of XOR is directed back to the RAi register of the same bit, representing the left column.

FIG. 11 is an adaptation of the adder, for three inputs. First, there are XOR and AND gates “2” and “3”. When all three inputs A, B, C′ are a high signal, then gates “2” and “3” both output a high signal so that the output of gate “4” is a high signal. This amounts to a high signal being sent to the RB register of the next bit. That is, a carry over. Simultaneously, a high signal is sent back to the RA register of the same bit. A unit remains in the same bit. The case when all the inputs of a bit are “1” result in a carry over and unit in the same bit. This is the only case in which gate “4” is on, so no more attention is paid to it.

In an embodiment, if only two of the three inputs are a high signal, then gates “2” and “3” will both be off. Specifically, the fact that gate “3” is off, implies that gate “5” is on. Simultaneously, two of the three gates “6, 7, 8” are on. This means gate “9” is receiving two high signals, so that its output is a high signal “1”. There is a carry over and no unit remains in that bit. The next case is when only one of three inputs is on. Gate “2” is off, and gate “3” is on; a unit remains in that bit, and no carry over is generated.

In an embodiment, if all inputs are off then gate “5” will be on, but gates “6, 7, 8” will be off so that gate “9” is also off. No carry overtakes place and there is no unit remaining, all cases have now been covered. The circuit whose elements are gates “2-9” is a one bit adder for three operands. Several bits are connected in series, to iterate until the system stabilizes. The control logic will remain the same.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

While various aspects and embodiments have been disclosed herein, other aspects and embodiments will be apparent to those skilled in the art. The various aspects and embodiments disclosed herein are for purposes of illustration and are not intended to be limiting, with the true spirit being indicated by the following claims.

What is claimed is:

1. A linear fast adder for an Arithmetic Logic Unit (ALU), the adder comprising:
a) a four-bit adder component comprising a plurality of logic gates comprising at least sixteen AND gates, four XOR gates; and
b) a plurality of one-bit registers; wherein the four-bit adder is configured with a linear area, linear complexity and a logarithmic delay; and wherein the four-bit adder has a constant gate depth thereby resulting in constant power dissipation.

2. The linear fast adder of claim 1, wherein the four-bit adder component is configured to support a plurality of operands for integer type data and rational approximations to real number type data.

3. The linear fast adder of claim 1, wherein the four-bit adder component is configured to perform operations comprising at least one of left shift operation, right shift operation, addition, signed operations and one or more derived operations.

4. The linear fast adder of claim 3, wherein performing the operations comprises: representing the numbers in a binary form in corresponding set of natural numbers, such that each number is a set of smaller natural numbers, wherein elements of the set of smaller numbers are denoted in powers of 2 in a binary representation.

5. The linear fast adder of claim 1 further comprises determining a symmetric difference corresponding to the operations performed at the four-bit adder component, the determining comprising:
a) saving an initial state of the operations in at least one one-bit registers in the four-bit adder component;
b) directing output of each of the one-bit registers in two disjoint paths; and
c) computing the symmetric difference and intersection in the output of each of the one-bit registers.

6. The linear fast adder of claim 5, wherein the bit configurations saved in the one-bit registers is passed through at least one XOR gate in the four-bit adder component for yielding the symmetric difference.

7. The linear fast adder of claim 5, wherein the bit configurations saved in the one-bit registers is passed through at least one AND gate in the four-bit adder component for determining an intersection in the output.

8. The linear fast adder of claim 1, wherein to represent a rational approximation of nonnegative real number, a fraction of the bits is used for the rational part and the remaining bits are used for the integer part.

9. The linear fast adder of claim 1, wherein adding a single bit to the operands requires adding of a sub-unit of four bits and five logic gates in a linear manner to the four-bit adder component.

10. The linear fast adder of claim 1, wherein the time taken by the linear fast adder is equal to sum of the two gate delays, and the reading and writing process.

11. The linear fast adder of claim 1, wherein clock cycles for the linear fast adder remains shorter depending on the gate depth and constant instructions, such that an increase in speed of memory writing process results in a compounded reduction of time.

12. The linear fast adder of claim 1, wherein an instruction set associated with the linear fast adder is constant and is independent of the number of bits of input provided to the linear fast adder.

13. The linear fast adder of claim 1, wherein the operation of the linear fast adder is controlled based on an arithmetic model that defines addition operations in terms of a finite state machine.

14. The linear fast adder of claim 13, wherein each state of the finite state machine comprises two columns and each column represents a finite configuration of energy levels representing one natural number.

15. The linear fast adder of claim 14, wherein in a subsequent set of the finite state machine, the finite configuration on a left column of the two columns represents the energy levels that are not repeated in the preceding state and the finite configuration on a right column of the two columns represents objects that are repeated from the preceding state.
